(19) United States
(12) Patent Application Publication
(10) Pub. No.: US 2015/0096454 A1
(43) Pub. Date: Apr. 9, 2015

(54) LIQUID TRANSFER DEVICE AND LIQUID TRANSFER METHOD

(71) Applicant: KOMORI CORPORATION, Tokyo (JP)

(72) Inventor: Hiroyuki Sugiyama, Tsukuba-shi (JP)

(73) Assignee: KOMORI CORPORATION, Tokyo (JP)

(21) Appl. No.: 14/396,821

(22) PCT Filed: Apr. 18, 2013
(86) PCT No.: PCT/JP2013/061438

§ 371 Date: Oct. 24, 2014

(30) Foreign Application Priority Data
Apr. 27, 2012 (JP) 2012-102424
Mar. 19, 2013 (JP) 2013-055864

(51) Int. Cl. B41F 13/193

(52) U.S. Cl. CPC B41F 13/193
USPC 101/217

(57) ABSTRACT

In the present invention, the following steps are carried out: a plate drum transfer step (S1) in which a rubber drum (B), a plate drum (P), and an impression drum (I) are caused to separate, and in a state where the impression drum (I), the plate drum (P), and the rubber drum (B) are caused to rotate, ink is transferred to the plate drum (P) from an ink application roller (R) and the ink from the ink application roller (R) is transferred so as to be further layered onto the ink transferred onto the plate drum (P); a blanket drum transfer step (S2) in which when the rubber drum (B) and the plate drum (P) are opposingly brought into contact with each other and ink from the plate drum (P) is transferred to the rubber drum (B), the transfer of ink is begun from the transferred ink that was layered onto the plate drum (P), and ink from the plate drum (P) is transferred so as to be further layered onto the ink transferred onto the rubber drum (B); and a sheet transfer step (S3) in which when the rubber drum (B) and the impression drum (I) are opposingly brought into contact with each other and ink from the rubber drum (B) is transferred to a sheet of the impression drum (I), the transfer of ink is begun from the transferred ink that was layered onto the rubber drum (B) to the sheet of the impression drum (I).

### TECHNICAL FIELD

The present invention relates to a liquid transfer device and a liquid transfer method for transferring a liquid to a sheet, and is particularly effective when applied to a sheet-fed offset printing press which prints ink on a sheet.

### BACKGROUND ART

For example, a sheet-fed offset printing press which prints ink on a sheet is configured such that the ink is supplied from an ink form roller of an inking device to a plate of a plate cylinder, then transferred to a blanket of a blanket cylinder in a pattern corresponding to a pattern of the plate, and thereafter transferred (printed) to a sheet held by an impression cylinder.

In such a sheet-fed offset printing press, the ink is transferred from an ink supply source to the sheet via many rollers and the like. Accordingly, a large amount of work is required to appropriately adjust an ink supply amount for the sheet at the start of a printing operation. To solve this problem, for example, Patent Literature 1 listed below and the like propose a sheet-fed offset printing press configured to detect an ink density on a printed sheet and adjust an ink supply amount from an inking device on the basis of the detected ink density.

### CITATION LIST

### Patent Literature

Patent Literature 1: Japanese Patent Application Publication 2006-103050

Patent Literature 2: Japanese Patent No. 3501844

### SUMMARY OF INVENTION

### Technical Problem

However, in the sheet-fed offset printing press described in Patent Literature 1 and the like, the ink density cannot be appropriately adjusted for a sheet printed immediately after start of the printing operation and the ink density on the sheet printed immediately after start of the printing operation is low. Accordingly, the sheet printed immediately after the start of the printing operation needs to be discarded as waste paper and sheets and ink are wasted.

Such a problem occurs not only in a sheet-fed offset printing press like one described above and may occur in a similar way in a case where a liquid is transferred from liquid transfer means to an outer peripheral surface of a liquid transfer cylinder and the liquid on the outer peripheral surface of the liquid transfer cylinder is transferred to a sheet held on an outer peripheral surface of an impression cylinder, as in a varnish transfer device configured to transfer varnish on a sheet, and the like.

In view of this, an object of the present invention is to provide a liquid transfer device and a liquid transfer method which can transfer a liquid to a sheet at a sufficient density even immediately after start of a running operation.

### Solution to Problem

A liquid transfer device of the present invention for solving the problem described above is a liquid transfer device including:

a rotatably-provided impression cylinder configured to hold a sheet on an outer peripheral surface thereof;

a rotatably-provided liquid transfer cylinder configured to be movable to be brought into contact with and separated from the impression cylinder;

liquid transfer means for transferring a liquid to an outer peripheral surface of the liquid transfer cylinder; and

control means for controlling contact and separating movement of the liquid transfer cylinder, rotating operations of the impression cylinder and the liquid transfer cylinder, and transferring operation of the liquid from the liquid transfer means to the liquid transfer cylinder, the liquid transfer device characterized in that

the control means controls the liquid transfer cylinder, the impression cylinder, and an operation of the liquid transfer means in such a way that: in a period between start of a running operation and transfer of the liquid to a first sheet, the liquid is repeatedly transferred from the liquid transfer means to the outer peripheral surface of the liquid transfer cylinder with the liquid transfer cylinder and the impression cylinder, which are separated from each other, being rotated; and thereafter the liquid on the outer peripheral surface of the liquid transfer cylinder is transferred to the first sheet.

Moreover, the liquid transfer device of the present invention is the aforementioned liquid transfer device characterized in that

the liquid is ink,

the liquid transfer means includes: a rotatably-provided plate cylinder with a plate attached to an outer peripheral surface thereof; and ink transfer means for transferring the ink to the plate of the plate cylinder,

the liquid transfer cylinder is a blanket cylinder with a blanket attached to an outer peripheral surface thereof, the blanket cylinder configured to be movable to be brought into contact with and separated from the impression cylinder and the plate cylinder, and

the control means controls the impression cylinder, the plate cylinder, an operation of the blanket cylinder, and the ink transfer means in such a way that: the ink is repeatedly transferred from the ink transfer means to the plate of the plate cylinder with the blanket cylinder separated from the plate cylinder and the impression cylinder and with the impression cylinder, the plate cylinder, and the blanket cylinder being rotated; then the ink on the plate cylinder is repeatedly transferred to the blanket cylinder by bringing the blanket cylinder into contact with the plate cylinder; and thereafter the ink on the blanket cylinder is transferred to the first sheet by bringing the blanket cylinder into contact with the impression cylinder.

Furthermore, the liquid transfer device of the present invention is the aforementioned liquid transfer device characterized in that

each of the plate cylinder, the blanket cylinder, and the impression cylinder has a gap portion formed on the outer peripheral surface thereof, and

the control means controls the operation of the blanket cylinder in such a way that: the blanket cylinder and the plate cylinder are brought into contact with each other when the gap portion of the plate cylinder and the gap portion of the blanket cylinder come to face each other; and the blanket cylinder and the impression cylinder are brought into contact with each other when the gap portion of the impression cylinder and the gap portion of the blanket cylinder come to face each other.

Meanwhile, a liquid transfer method of the present invention for solving the problems described above is a liquid transfer method of transferring a liquid from liquid transfer means to an outer peripheral surface of a liquid transfer cylinder and transferring the liquid on the outer peripheral surface of the liquid transfer cylinder to a sheet held on an outer peripheral surface of an impression cylinder, characterized in that the liquid transfer method comprises:

a liquid transfer cylinder transfer step of, in a period between start of a running operation and transfer of the liquid to a first sheet, repeatedly transferring the liquid from the liquid transfer means to the outer peripheral surface of the liquid transfer cylinder with the liquid transfer cylinder and the impression cylinder, which are separated from each other, being rotated; and

a sheet transfer step of transferring the liquid to the first sheet by bringing the liquid transfer cylinder and the impression cylinder into contact with each other after the liquid transfer cylinder transfer step.

Moreover, the liquid transfer method of the present invention is the aforementioned liquid transfer method characterized in that

the liquid is ink,

the liquid transfer means includes: a rotatably-provided plate cylinder with a plate attached to an outer peripheral surface thereof; and ink transfer means for transferring the ink to the plate of the plate cylinder,

the liquid transfer cylinder is a blanket cylinder with a blanket attached to an outer peripheral surface thereof, the blanket cylinder configured to be movable to be brought into contact with and separated from the impression cylinder and the plate cylinder, and

the liquid transfer cylinder transfer step is a step including:
a plate cylinder transfer step of repeatedly transferring the ink from the ink transfer means to the plate of the plate cylinder with the blanket cylinder separated from the plate cylinder and the impression cylinder and with the impression cylinder, the plate cylinder, and the blanket cylinder being rotated; and
a blanket cylinder transfer step of repeatedly transferring the ink on the plate cylinder to the blanket cylinder by bringing the blanket cylinder into contact with the plate cylinder, and

the sheet transfer step is a step of transferring the ink on the blanket cylinder to the first sheet by bringing the blanket cylinder into contact with the impression cylinder.

Furthermore, the liquid transfer method of the present invention is the aforementioned liquid transfer method characterized in that

each of the plate cylinder, the blanket cylinder, and the impression cylinder has a gap portion formed on the outer peripheral surface thereof, and

the blanket cylinder transfer step is a step of bringing the blanket cylinder and the plate cylinder into contact with each other when the gap portion of the plate cylinder and the gap portion of the blanket cylinder come to face each other, and

the sheet transfer step is a step of bringing the blanket cylinder and the impression cylinder into contact with each other when the gap portion of the impression cylinder and the gap portion of the blanket cylinder come to face each other.

### Advantageous Effects of Invention

In the liquid transfer device and the liquid transfer method of the present invention, the liquid can be transferred at a sufficient density from the first sheet even immediately after the start of the liquid transfer operation. Accordingly, it is possible to eliminate generation of sheets with low liquid density immediately after the start of the liquid transfer operation and effectively use the sheets and the liquid.

### BRIEF DESCRIPTION OF DRAWINGS

FIG. 1 is a schematic configuration diagram of a main portion of a main embodiment in which a liquid transfer device of the present invention is applied to a sheet-fed offset printing press.

FIG. 2 is a control block diagram of the main portion of the sheet-fed offset printing press of FIG. 1.

FIG. 3 is a diagram explaining an operation of the main portion of the sheet-fed offset printing press of FIG. 1.

FIG. 4 is a diagram explaining an operation subsequent to FIG. 3.

FIG. 5 is a diagram explaining an operation subsequent to FIG. 4.

FIG. 6A is a chart showing change in ink transfer amount in phase states of the sheet-fed offset printing press in the embodiment, and FIG. 6B is a chart showing the same in the conventional technique.

FIG. 7 is a graph showing relationships between the ink thickness on the printed sheet and the number of printed sheets.

FIG. 8 is a schematic configuration view of a main portion of an embodiment in which the liquid transfer device of the present invention is applied to a varnish transfer device.

### DESCRIPTION OF EMBODIMENTS

Embodiments of a liquid transfer device and a liquid transfer method of the present invention are described based on the drawings. However, the liquid transfer device and the liquid transfer method of the present invention are not limited to the embodiments described below based on the drawings.

### Main Embodiment

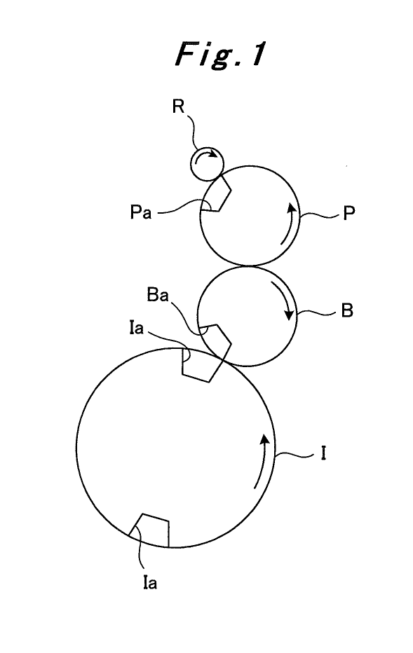

A main embodiment in which a liquid transfer device of the present invention is applied to a sheet-fed offset printing press is described based on FIGS. 1 to 7.

As shown in FIG. 1, a rotatably-supported blanket cylinder B which is a liquid transfer cylinder with a rubber blanket detachably attached to an outer peripheral surface is into contact with an outer surface of a rotatably-supported impression cylinder I configured to detachably hold a sheet on the outer peripheral surface. A rotatably-supported plate cylinder P with a plate detachably attached to an outer peripheral surface is into contact with the outer peripheral surface of the blanket cylinder B. An ink form roller R of an inking device configured to supply ink which is a liquid is into contact with the outer peripheral surface of the plate cylinder P. Sheets are fed to the impression cylinder I one by one from a not-illustrated sheet feeding device which is sheet feeding means for feeding the sheets. The impression cylinder I can pass and send out the held sheet to a not-illustrated delivery device which is sheet delivering means for delivering the sheets.

Gap portions Ia each housing a gripping unit (not illustrated) configured to detachably hold a sheet are formed on an outer peripheral surface of the impression cylinder I in such a way that the longitudinal directions of the gap portions Ia extend along an axial direction. The impression cylinder I has two gap portions Ia arranged at equal intervals in a circumferential direction of the outer peripheral surface (double-size cylinder). A gap portion Ba housing a blanket holding unit (not illustrated) configured to detachably hold the blanket is formed on the outer peripheral surface of the blanket cylinder B in such a way that the longitudinal direction of the gap portion Ba extends along the axial direction. The blanket cylinder B has one notch portion Ba on the outer peripheral surface (single-size cylinder). A gap portion Pa housing a plate holding unit (not illustrated) configured to detachably hold the plate is formed on the outer peripheral surface of the plate cylinder P in such a way that the longitudinal direction of the gap portion Pa extends along the axial direction. The plate cylinder P has one gap portion Pa on the outer peripheral surface (single-size cylinder).

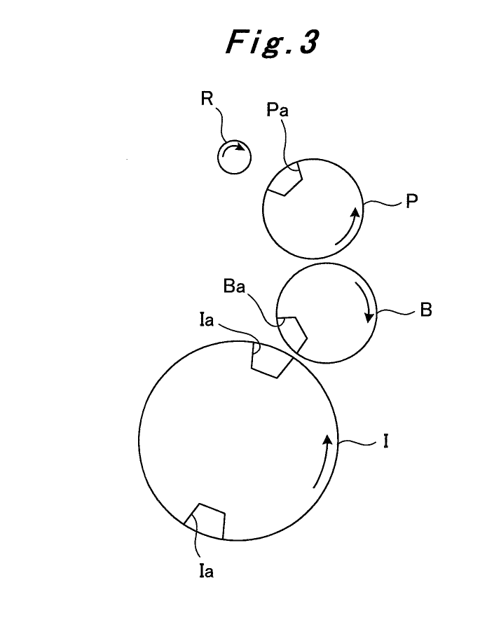

Rotary shafts of the cylinders I, B, and P are connected to each other by gear trains and the cylinders I, B, and P can rotate synchronously with each other. Moreover, the inking device is movable in such a way that the ink form roller R can be brought into contact with (see FIGS. 1, 4, and 5) and separated from (see FIG. 3) the plate cylinder P.

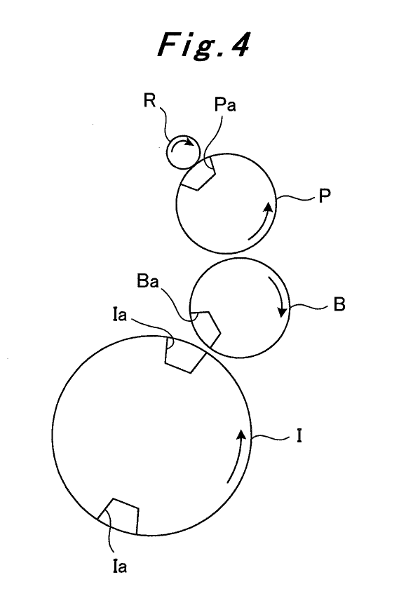

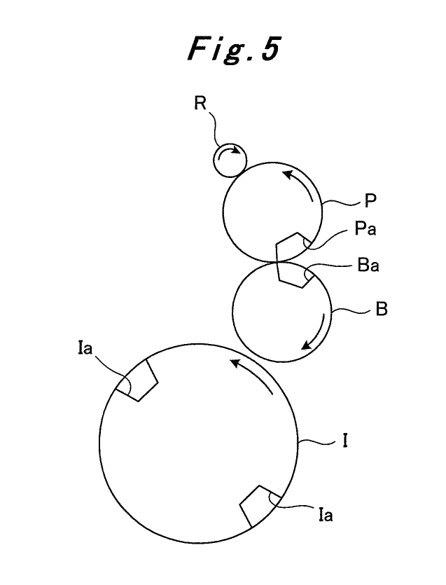

The blanket cylinder B is rotatably supported via an eccentric bearing. By turning the eccentric bearing, the blanket cylinder B can be separated from both of the impression cylinder I and the plate cylinder P (impression throw-off) (see FIGS. 3 and 4), brought into contact with the plate cylinder P while being separated from the impression cylinder I (see FIG. 5), and brought into contact with both of the impression cylinder I and the plate cylinder P (impression on) (see FIG. 1). Note that the blanket cylinder B is connected to the impression cylinder I and the plate cylinder P via the gear trains not only in the impression on state but also in the impression throw-off state.

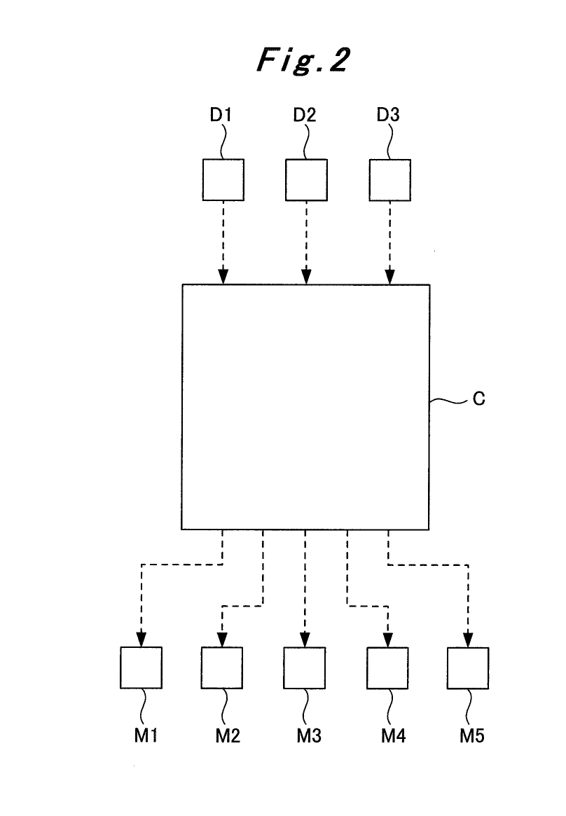

As shown in FIG. 2, output portions of a control device C which is control means are electrically connected respectively to: a drive motor M1 configured to synchronously drive and rotate the cylinders I, B, and P; an ink supply motor M2 configured to cause the inking device to operate in such a way that the ink is supplied to the ink form roller R; an inking device engagement-disengagement motor M3 configured to move the inking device in such a way that the ink form roller R is brought into contact with and separated from the plate cylinder P; a blanket cylinder engagement-disengagement motor M4 configured to turn the eccentric bearing in such a way that the blanket cylinder B is brought into contact with and separated from the impression cylinder I and the plate cylinder P; and a feeding device drive source M5 configured to cause the feeding device to operate. An input unit D1 which starts or stops a printing operation, a rotational speed detecting unit D2 which is rotational speed detecting means for detecting the rotational speeds of the cylinders I, B, and P, and a phase detecting unit D3 which is phase detecting means for detecting rotational phases of the cylinders I, B, and P are electrically connected respectively to input portions of the control device C. The control device C can control operations respectively of the motors M1 to M4 and the drive source M5 on the basis of information from the input unit D1, the rotational speed detecting unit D2, and the phase detecting unit D3 (details are described later).

Note that, in the embodiment, the inking device having the ink form roller R forms ink transfer means, and the ink transfer means and the plate cylinder P form liquid transfer means.

Next, description is given of operations (liquid transfer method) of the sheet-fed offset printing press in the embodiment described above.

Before the start of the printing operation, the eccentric bearing is turned in such a way that the inking device is located at a position where the ink form roller R is separated from the plate cylinder P and that the blanket cylinder B is located at a position separated from the impression cylinder I and the plate cylinder P (see FIG. 3). When a command to start the operation is inputted to the control device C from the input unit D1 in this state, the control device C controls the operation of the drive motor M1 on the basis of information from the input unit d1, in such a way that the cylinders I, B, and P are synchronously rotated. Moreover, the control device C controls the operation of the ink supply motor M2 in such a way that the ink is supplied to the ink form roller R of the inking device.

When the ink form roller R of the inking device is rotated a predetermined number of times and the ink of a necessary and sufficient thickness (for example, film thickness: 8 μm) is supplied to the outer peripheral surface of the ink form roller R, the control device C controls the operations of the motors M2 to M4 and the drive source M5 at the following timings on the basis of information from the rotational speed detecting unit D2 and the phase detecting unit D3.

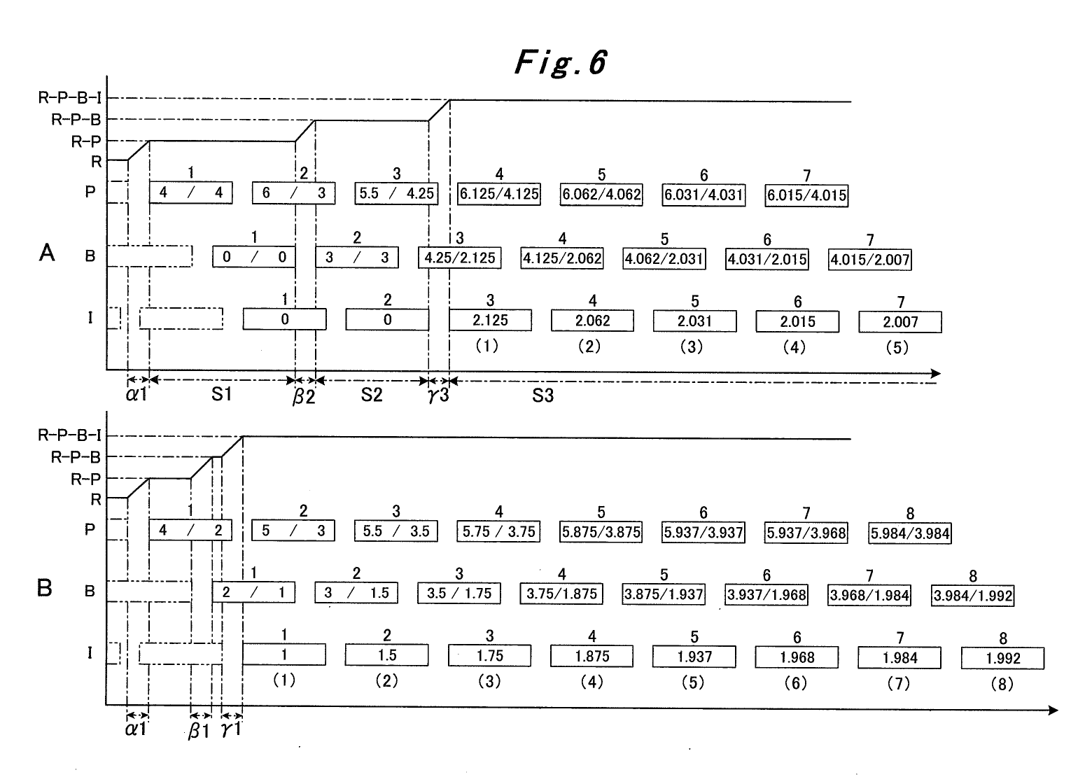

First, the control device C moves the inking device by controlling (see FIG. 4) the operation of the inking device engagement-disengagement motor M3 on the basis of information from the rotational speed detecting unit D2 and the phase detecting unit D3 in such a way that the ink form roller R is brought into contact with the outer peripheral surface of the plate cylinder P when the gap portion Pa of the plate cylinder P and the ink form roller R come to face each other (section α1 in FIG. 6A).

This causes the ink of the preset thickness (for example, film thickness: 8 μm) formed on the outer peripheral surface of the ink form roller R to be transferred (generally, transfer ratio is 50%) to the plate on the outer peripheral surface of the plate cylinder P, and a film of the ink (film thickness: 4 μm) is formed on the plate of the plate cylinder P. Note that a film of the ink (film thickness: 4 μm) not transferred onto the plate of the plate cylinder P is left on the outer peripheral surface of the ink form roller R.

When the plate cylinder P is rotated one turn with the ink form roller R brought into contact with the plate cylinder P as described above, the film of ink (film thickness: 4 μm) is formed over the entire periphery of the plate of the plate cylinder P. At this time, the blanket cylinder B and the impression cylinder I are also synchronously rotated (first turn). However, since the blanket cylinder B is separated from the impression cylinder I and the plate cylinder P without coming into contact therewith, no ink is transferred to the blanket cylinder B and the impression cylinder I (film thickness: 0 μm).

Next, in the second turn of the plate cylinder P after the ink form roller R is brought into contact with the plate cylinder P, a film of the ink of the same thickness (for example, film thickness: 8 μm) as the last time is formed on the outer peripheral surface of the ink form roller R continuously supplied with the ink. Due to this, the ink on the ink form roller R is applied in an overlaid manner (total thickness: 12 μm) and transferred (transfer ratio: 50%) to the film of ink (film thickness: 4 μm) on the plate cylinder P. A film of repeatedly-applied ink (film thickness: 6 μm) is thereby formed on the plate of the plate cylinder P (the above step is referred to as plate cylinder transfer step S1).

After the film of ink (film thickness: 6 μm) is formed on the plate cylinder P as described above, the film of ink is transferred to the blanket of the blanket cylinder B. Specifically, at the start of the second turn of the blanket cylinder B after the ink form roller R is brought into contact with the plate cylinder P, the control device C turns the eccentric bearing and moves the blanket cylinder B by controlling (see FIG. 5) the operation of the blanket cylinder engagement-disengagement motor M4 on the basis of information from the rotational speed detecting unit D2 and the phase detecting unit D3 in such a way that the blanket cylinder B is brought into contact with the outer peripheral surface of the plate cylinder P when the gap portion Pa of the plate cylinder P comes to face the gap portion Ba of the blanket cylinder B (section α2 in FIG. 6A).

This causes the ink to be transferred (transfer ratio: 50%) to the blanket of the blanket cylinder B from the film of ink (film thickness: 6 μm) formed on the plate of the plate cylinder P by being repeatedly applied, and a film of the ink (film thickness: 3 μm) is thereby formed on the blanket.

When the blanket cylinder B is rotated one turn while being brought into contact with the plate cylinder P, the film of ink (film thickness: 3 μm) is formed over the entire periphery of the blanket of the blanket cylinder B. At this time, the impression cylinder I is also synchronously rotated (second turn). However, since the blanket cylinder B is into contact only with the plate cylinder P and is separated from the impression cylinder I without coming into contact therewith, no ink is transferred to the impression cylinder I (film thickness: 0 μm).

Next, in the third turn after the ink form roller R is brought into contact with the plate cylinder P, the film of ink (film thickness: 8 μm) on the outer surface of the ink form roller R continuously supplied with the ink is applied again in an overlaid manner (total film thickness: 11 μm) and transferred (transfer ratio: 50%) to the film of ink (film thickness: 3 μm) left on the plate of the plate cylinder P after the transfer of the ink to the blanket cylinder B. A film of the repeatedly-applied ink (film thickness: 5.5 μm) is thereby formed on the plate of the plate cylinder P. The film of ink on the plate of the plate cylinder P is thus replenished (replenishment film thickness: 2.5 μm).

When a plate portion of the plate cylinder P replenished with the ink comes into contact with the blanket cylinder B, i.e. in the third turn of the blanket cylinder B after the ink form roller R is brought into contact with the plate cylinder P, the ink is applied in an overlaid manner (total film thickness: 8.5 μm) and transferred (transfer ratio: 50%) to the film of ink (film thickness: 3 μm) on the blanket cylinder B from the film of ink (film thickness: 5.5 μm) transferred to the plate of the plate cylinder P. A film of the repeatedly-applied ink (film thickness: 4.25 μm) is thereby formed on the blanket of the blanket cylinder B. The film of ink on the blanket of the blanket cylinder B is thus replenished (replenishment film thickness: 1.25 μm) (the above step is referred to as blanket cylinder transfer step S2).

After the ink is repeatedly transferred to the blanket cylinder B as described above, the ink is transferred to the first sheet on the impression cylinder I. Specifically, when the impression cylinder I is rotated one and a half turn (in the third turn in terms of a single-size cylinder) after the ink form roller R is brought into contact with the plate cylinder P, the control device C turns the eccentric bearing and moves the blanket cylinder B by controlling (see FIG. 1) the operation of the blanket cylinder engagement-disengagement motor M4 on the basis of information from the rotational speed detecting unit D2 and the phase detecting unit D3 in such a way that the blanket cylinder B is brought into contact with the outer peripheral surface of the impression cylinder I when the gap portion Ba of the blanket cylinder B and one of the gap portions Ia of the impression cylinder I come to face each other (section γ3 in FIG. 6A).

At this time, since the first sheet is held on the outer peripheral surface of the impression cylinder I, the ink is transferred (transfer ratio: 50%) onto the first sheet held on the outer peripheral surface of the impression cylinder I from the film of ink (film thickness: 4.25 μm) repeatedly formed on the blanket of the blanket cylinder B, and a film of the ink is thereby formed (film thickness: 2.125 μm) on the first sheet.

Hereafter, by continuing the operation, the ink can be sequentially transferred (printed) to sheets supplied one after another from the feeding device to the impression cylinder I (the above step is referred to as sheet transfer step S3). Here, as shown in FIG. 6A, the film thickness of the ink to be transferred (printed) becomes smaller sequentially for the second and subsequent sheets and gradually converges to a predetermined target film thickness.

As described above, the control device C controls the start timings of the steps S1 to S3 in a manner synchronized with the timing of supplying the first sheet.

Specifically, the following operations are performed in the conventional technique. As shown in FIG. 6B, when the ink form roller R of the inking device is rotated a predetermined number of times and the ink of a necessary and sufficient thickness is supplied to the outer peripheral surface of the ink form roller R, the inking device is moved in such a way that the ink form roller R is brought into contact with the outer peripheral surface of the plate cylinder P when the gap portion Pa of the plate cylinder P and the ink form roller R come to face each other (section β1 in FIG. 6B). Next, the blanket cylinder B is moved to be brought into contact with the outer peripheral surface of the plate cylinder P when the gap portion Pa of the plate cylinder P and the gap portion Ba of the blanket cylinder B come to face each other (section β1 in FIG. 6B). Subsequently, the blanket cylinder B is moved to be brought into contact with the outer peripheral surface of the impression cylinder I when the gap portion Ba of the blanket cylinder B and one of the gap portions Ia of the impression cylinder I come to face each other (section γ1 in FIG. 6B). In summary, when the ink form roller R is brought into contact with the plate cylinder P, in the first turn after the ink form roller R is brought into contact with the plate cylinder P, the blanket cylinder B is moved in such a way that the cylinders P, B, and I are all brought into contact with one another. However, the following operations are performed in the embodiment. As shown in FIG. 6A, when the ink form roller R of the inking device is rotated a predetermined number of times and the ink of a necessary and sufficient thickness is supplied to the outer peripheral surface of the ink form roller R, the inking device is moved in such a way that the ink form roller R is brought into contact with the outer peripheral surface of the plate cylinder P when the gap portion Pa of the plate cylinder P and the ink form roller R come to face each other (section α1 in FIG. 6A). Thereafter, the ink is transferred from the ink form roller R of the inking device to the plate of the plate cylinder P with the blanket cylinder B separated from the plate cylinder P and the impression cylinder I, and the ink is thereby transferred in an overlaid manner from the ink form roller R of the inking device to the ink transferred to the plate of the plate cylinder P (step S1 in FIG. 6A). Then, the blanket cylinder B is moved to be brought into contact with the outer peripheral surface of the plate cylinder P when the gap portion Pa of the plate cylinder P and the gap portion Ba of the blanket cylinder B come to face each other (section β2 in FIG. 6A). Thereafter, the ink is transferred from the plate of the plate cylinder P to the blanket of the blanket cylinder B with the blanket cylinder B separated from the impression cylinder I, and the ink is thereby transferred in an overlaid manner from the plate of the plate cylinder P to the ink transferred to the blanket of the blanket cylinder B (step S2 in FIG. 6A). Then, the blanket cylinder B is moved to be brought into contact with the outer peripheral surface of the plate cylinder P when the gap portion Pa of the plate cylinder P and the gap portion Ba of the blanket cylinder B come to face each other (section γ3 in FIG. 6A). The blanket cylinder B and the impression cylinder I are thus brought into contact with each other and the ink is transferred from the blanket of the blanket cylinder B to the sheet on the impression cylinder I. The ink repeatedly transferred to the blanket of the blanket cylinder B is thereby printed on the sheet (step S3 in FIG. 6A). In summary, when the ink form roller R is brought into contact with the plate cylinder P, in the first turn of the plate cylinder P after the ink form roller R is brought into contact with the plate cylinder P, the cylinders P, B, and I are not brought into contact with and separated from one another to transfer the ink only to the plate cylinder P and the ink is thereby repeatedly transferred to the plate cylinder P. In the second turn of the blanket cylinder B after the ink form roller R is brought into contact with the plate cylinder P, the plate cylinder P and the blanket cylinder B are brought into contact with each other and the ink is thereby repeatedly transferred also to the blanket cylinder B. When the impression cylinder I is rotated one and a half turn (in the third turn in terms of a single-size cylinder) after the ink form roller R is brought into contact with the plate cylinder P, the blanket cylinder B is moved in such way that the blanket cylinder B and the impression cylinder I are brought into contact with each other and the ink repeatedly transferred to the blanket cylinder B is thereby printed on the sheet.

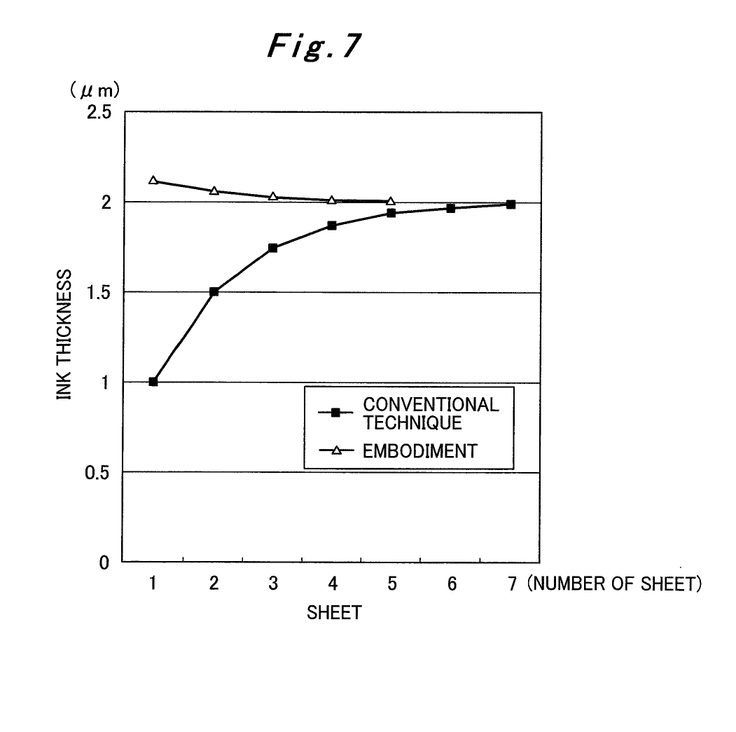

Hence, as shown in FIG. 7, in the conventional technique, the ink to be printed (transferred) on the sheet gradually becomes thicker (higher in density) and reaches the target thickness (for example, 2±0.2 μm) in the fourth sheet. Meanwhile, in the embodiment, the ink can reach the target thickness (for example, 2±0.2 μm) in the first sheet.

Accordingly, in the embodiment, the ink can be transferred at a sufficient density from the first sheet even immediately after the start of the printing operation. Hence, it is possible to eliminate generation of waste paper with low ink density immediately after the start of the printing operation and effectively use the sheets and the ink.

### Other Embodiments

In the aforementioned embodiment, in the first turn after the ink form roller R is brought into contact with the plate cylinder P, the cylinders P, B, and I are not brought into contact with and separated from one another to transfer the ink only to the plate cylinder P and the ink is thereby repeatedly transferred to the plate cylinder P, in the second turn after the ink form roller R is brought into contact with the plate cylinder P, only the plate cylinder P and the blanket cylinder B are brought into contact with each other and the ink is thereby repeatedly transferred also to the blanket cylinder B, and in the third turn after the ink form roller R is brought into contact with the plate cylinder P, the blanket cylinder B is moved in such way that the blanket cylinder B and the impression cylinder I are brought into contact with each other and the ink repeatedly transferred to the blanket cylinder B is thereby printed on the sheet. In other words, the number of turns for repeatedly transferring the ink by sequentially bringing the cylinders into contact with one another is one for each cylinder. However, as another embodiment, for example, the number of turns for repeatedly transferring the ink by sequentially bringing the cylinders into contact with one another may be two or more for each cylinder.

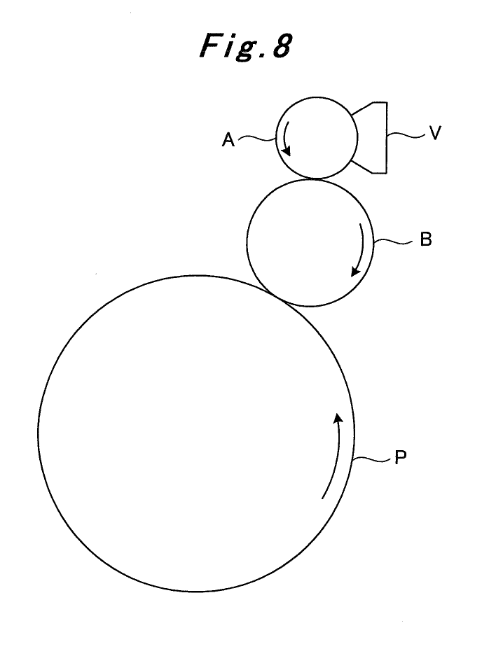

Moreover, in the aforementioned embodiment, description is given of the case where the invention is applied to the sheet-fed offset printing press including the impression cylinder I, the blanket cylinder B, the plate cylinder P, and the inking device. However, as another embodiment, the invention can be applied to a case where a liquid is transferred from liquid transfer means to an outer surface of a liquid transfer cylinder and the liquid on the outer surface of the liquid transfer cylinder is transferred to a sheet held on an outer peripheral surface of an impression cylinder, as in, for example, a varnish transfer device shown in FIG. 8 which is provided with an varnish supplying device (liquid transfer means) V including the impression cylinder I, the blanket cylinder (liquid transfer cylinder) B, and an anilox roller A and which transfers varnish being the liquid to the sheet. In this case, operations and effects similar to those of the aforementioned embodiment can be obtained.

In the varnish transfer device described above, there is no member corresponding to the plate cylinder P in the sheet-fed offset printing press described in the aforementioned embodiment. Accordingly, there is performed a liquid transfer cylinder transfer step in which the plate cylinder transfer step S1 and the blanket cylinder transfer step S2 are integrated. Specifically, in the liquid transfer cylinder transfer step, the control means controls the blanket cylinder B, the impression cylinder I, and an operation of the varnish supply device V in such a way that the varnish is transferred from the anilox roller A of the varnish supply device V to the outer peripheral surface of the blanket cylinder B with the blanket cylinder B and the impression cylinder I separated from each other and with the blanket cylinder B and the impression cylinder I being rotated, and the varnish from the varnish supply device V is thereby transferred in an overlaid manner to the varnish transferred to the outer peripheral surface of the blanket cylinder B. Then, when the varnish is to be transferred to the sheet by bringing the blanket cylinder B into contact with the impression cylinder I, there is performed a sheet transfer step in which the operation of the blanket cylinder B is controlled to start transfer of the varnish to the sheet from the varnish repeatedly transferred on the outer peripheral surface of the blanket cylinder B.

### INDUSTRIAL APPLICABILITY

The liquid transfer device and the liquid transfer method of the present invention can eliminate generation of a sheet with low liquid density immediately after the start of the liquid transfer operation and effectively use the sheets and the ink. Accordingly, the liquid transfer device and the liquid transfer method can be highly useful in printing industries and the like when applied to, for example, a sheet-fed offset printing press.

### REFERENCE SIGNS LIST

I Impression cylinder
Ia Gap portion
B Blanket cylinder
Ba Gap portion
P Plate cylinder
Pa Gap portion
R Ink form roller
C Control device
D1 Input unit
D2 Rotational speed detecting unit
D3 Phase detecting unit
M1 Drive motor
M2 Ink supply motor
M3 Inking device engagement-disengagement motor
M4 Blanket cylinder engagement-disengagement motor
M5 Feeding device drive source

1. A liquid transfer device comprising:
a rotatably-provided impression cylinder configured to hold a sheet on an outer peripheral surface thereof;
a rotatably-provided liquid transfer cylinder configured to be movable to be brought into contact with and separated from the impression cylinder;
liquid transfer means for transferring a liquid to an outer peripheral surface of the liquid transfer cylinder; and
control means for controlling contact and separating movement of the liquid transfer cylinder, rotating operations of the impression cylinder and the liquid transfer cylinder, and transferring operation of the liquid from the liquid transfer means to the liquid transfer cylinder, wherein
the control means controls the liquid transfer cylinder, the impression cylinder, and an operation of the liquid transfer means in such a way that: in a period between start of a running operation and transfer of the liquid to a first sheet, the liquid is repeatedly transferred from the liquid transfer means to the outer peripheral surface of the liquid transfer cylinder with the liquid transfer cylinder and the impression cylinder, which are separated from each other, being rotated; and thereafter the liquid on the outer peripheral surface of the liquid transfer cylinder is transferred to the first sheet.

2. The liquid transfer device according to claim 1, wherein
the liquid is ink,
the liquid transfer means includes: a rotatably-provided plate cylinder with a plate attached to an outer peripheral surface thereof; and ink transfer means for transferring the ink to the plate of the plate cylinder,
the liquid transfer cylinder is a blanket cylinder with a blanket attached to an outer peripheral surface thereof, the blanket cylinder configured to be movable to be brought into contact with and separated from the impression cylinder and the plate cylinder, and
the control means controls the impression cylinder, the plate cylinder, an operation of the blanket cylinder, and the ink transfer means in such a way that: the ink is repeatedly transferred from the ink transfer means to the plate of the plate cylinder with the blanket cylinder separated from the plate cylinder and the impression cylinder and with the impression cylinder, the plate cylinder, and the blanket cylinder being rotated; then the ink on the plate cylinder is repeatedly transferred to the blanket cylinder by bringing the blanket cylinder into contact with the plate cylinder; and thereafter the ink on the blanket cylinder is transferred to the first sheet by bringing the blanket cylinder into contact with the impression cylinder.

3. The liquid transfer device according to claim 2, wherein
each of the plate cylinder, the blanket cylinder, and the impression cylinder has a gap portion formed on the outer peripheral surface thereof, and
the control means controls the operation of the blanket cylinder in such a way that: the blanket cylinder and the plate cylinder are brought into contact with each other when the gap portion of the plate cylinder and the gap portion of the blanket cylinder come to face each other; and the blanket cylinder and the impression cylinder are brought into contact with each other when the gap portion of the impression cylinder and the gap portion of the blanket cylinder come to face each other.

4. A liquid transfer method of transferring a liquid from liquid transfer means to an outer peripheral surface of a liquid transfer cylinder and transferring the liquid on the outer peripheral surface of the liquid transfer cylinder to a sheet held on an outer peripheral surface of an impression cylinder, comprising:
a liquid transfer cylinder transfer step of, in a period between start of a running operation and transfer of the liquid to a first sheet, repeatedly transferring the liquid from the liquid transfer means to the outer peripheral surface of the liquid transfer cylinder with the liquid transfer cylinder and the impression cylinder, which are separated from each other, being rotated; and
a sheet transfer step of transferring the liquid to the first sheet by bringing the liquid transfer cylinder and the impression cylinder into contact with each other after the liquid transfer cylinder transfer step.

5. The liquid transfer method according to claim 4, wherein
the liquid is ink,
the liquid transfer means includes: a rotatably-provided plate cylinder with a plate attached to an outer peripheral surface thereof; and ink transfer means for transferring the ink to the plate of the plate cylinder,
the liquid transfer cylinder is a blanket cylinder with a blanket attached to an outer peripheral surface thereof, the blanket cylinder configured to be movable to be brought into contact with and separated from the impression cylinder and the plate cylinder, and
the liquid transfer cylinder transfer step is a step including:
a plate cylinder transfer step of repeatedly transferring the ink from the ink transfer means to the plate of the plate cylinder with the blanket cylinder separated from the plate cylinder and the impression cylinder and with the impression cylinder, the plate cylinder, and the blanket cylinder being rotated; and
a blanket cylinder transfer step of repeatedly transferring the ink on the plate cylinder to the blanket cylinder by bringing the blanket cylinder into contact with the plate cylinder, and
the sheet transfer step is a step of transferring the ink on the blanket cylinder to the first sheet by bringing the blanket cylinder into contact with the impression cylinder.

6. The liquid transfer method according to claim 5, wherein
each of the plate cylinder, the blanket cylinder, and the impression cylinder has a gap portion formed on the outer peripheral surface thereof, and
the blanket cylinder transfer step is a step of bringing the blanket cylinder and the plate cylinder into contact with each other when the gap portion of the plate cylinder and the gap portion of the blanket cylinder come to face each other, and
the sheet transfer step is a step of bringing the blanket cylinder and the impression cylinder into contact with each other when the gap portion of the impression cylinder and the gap portion of the blanket cylinder come to face each other.
